(19) United States
(12) Patent Application Publication
(10) Pub. No.: US 2007/0011718 A1
(43) Pub. Date: Jan. 11, 2007

(54) EFFICIENT CUSTOMIZED MEDIA CREATION THROUGH PRE-ENCODING OF COMMON ELEMENTS

(76) Inventor: Patrick W. Nee JR., Old Greenwich, CT (US)

Correspondence Address: Walker Digital Management, LLC, Two High Ridge Park, Stamford, CT, 06905, US

(21) Appl. No.: 11/424,695

(22) Filed: Jun. 16, 2006

Related U.S. Application Data
(60) Provisional application No. 60/697,645, filed on Jul. 8, 2005.
(60) Provisional application No. 60/705,890, filed on Aug. 5, 2005.

(51) Int. Cl. H04N 7/16; H04N 7/173

(52) U.S. Cl. 725/135; 725/112; 725/113

(57) ABSTRACT

A video clip containing certain customizable portions may be mass produced such that each copy of the video clip may be unique relative to the other copies. This customization is effectuated by pre-encoding the common elements and any reusable dynamic elements. Then, as the video clip is produced, the pre-encoded elements are combined to form the customized video clip.

### RELATED APPLICATIONS

The present application claims the benefit of U.S. Provisional Application Ser. Nos. 60/697,645, filed Jul. 8, 2005 and 60/705,890, filed Aug. 5, 2005, both entitled APPARATUS AND METHODS FOR PRODUCING UNIQUE MEDIA EN MASSE and the disclosures of which are hereby incorporated by reference in their entireties.

### FIELD OF THE INVENTION

The present invention is related to pre-encoding unique audio and video content in a manner that allows mass production of the same.

### BACKGROUND OF THE INVENTION

The encoding of media, such as encoding video with MPEG-2 for use in DVD-video applications, is computationally intensive. While preparation times are acceptable for single-copy applications such as home movies, for applications that will be identically replicated en masse, such as pre-recorded DVDs, or even real-time applications such as video streaming, these same preparation times are unacceptable for producing en masse unique media in which the media content differs from one unit to the next.

### BRIEF DESCRIPTION OF THE DRAWINGS

FIG. 1 illustrates a flow diagram of a CHOOSE YOUR OWN ADVENTURE-style plot;

FIG. 2 illustrates a flow diagram of a method for implementing mass production of the plot of FIG. 1;

FIG. 3 illustrates a second environment suitable for use with embodiments of the present invention;

FIG. 4 illustrates a flow diagram of a method for implementing mass production of the environment of FIG. 3;

FIG. 5 illustrates a third environment suitable for use with embodiments of the present invention;

FIG. 6 illustrates a number of reusable dynamic elements suitable for use with the environment of FIG. 5;

FIG. 7 illustrates a number of alternate reusable dynamic elements suitable for use with the environment of FIG. 5;

FIG. 8 illustrates a flow diagram of a method for implementing mass production of the environment of FIG. 5;

FIG. 9 illustrates an exemplary system suited for implementing embodiments of the present invention;

FIG. 10 illustrates a first database with possible event outcomes for use with embodiments of the present invention;

FIG. 11 illustrates a second database with media file information about possible event outcomes for use with embodiments of the present invention;

FIG. 12 illustrates a third database with sectional element information for use with embodiments of the present invention;

FIG. 13 illustrates an alternate database with sectional element information for use with embodiments of the present invention;

FIG. 14 illustrates a database with information about a construction media segment for use with embodiments of the present invention; and

FIG. 15 illustrates a constructed media segment according to one or more embodiments of the present invention.

### DETAILED DESCRIPTION OF THE INVENTION

Embodiments of the present invention are designed to allow for the mass production of video clips wherein the video content of the video clips may vary from copy to copy within the production run. The present invention facilitates this activity by identifying common elements within each copy of the video content. These common elements are pre-encoded according to an encoding algorithm and stored. Elements that vary between the copies (also known as dynamic elements) are then pre-encoded and may be stored. When a copy is made, the pre-encoded common elements and the appropriate dynamic elements are combined to form a single pre-encoded video. The video is then transferred to a video medium to form a video clip. As the different copies are made, the common elements are reused and the appropriate dynamic elements are added thereto such that one copy may differ from another copy through the use of different dynamic content. In this manner, the common element does not have to be re-encoded each time a video clip is made.

Embodiments of the present invention are particularly well suited for use in the gaming industry to produce video content showing multiple outcomes for a gaming device. In such embodiments, the appearance of the gaming device is common to each copy that is to be made. Likewise, the particular indicia used by the gaming device may appear in multiple copies, but arranged differently between the myriad copies (in effect becoming reusable dynamic elements). However, by pre-encoding the common elements and the reused dynamic elements, and by selectively assembling these pre-encoded elements into a video clip, processing power is conserved during the production of multiple copies. This reduction in processing power may in turn accelerate production of the multiple copies. For example, if an entity needed to make fifty DVDs of fifty outcomes of a three-reel slot machine, the present invention would pre-encode the appearance of the slot machine, the symbols on the reel (e.g., bar, cherry, lemon, etc.), and then assemble the pre-encoded elements as needed for each of the fifty individual videos. Each individual video is then transferred to its own DVD. Instead of encoding the imagery of the slot machine 2500 times (once for each reel spin on each of the fifty copies), the present invention only encodes the slot machine imagery once and reuses it for each video clip. While the discussion herein focuses on video based embodiments, it should be appreciated that the present invention may also be applied equally to audio elements such as for an audio book, audio game, or the like.

To assist in understanding embodiments of the present invention and the attached claims, the following terms are specifically defined.

A “common element” is an element that appears substantially identically within the video content between multiple copies of the video content. Common elements have two specifically contemplated varieties. The first variety of a common element is a “fixed common element”. The second common element is a “changing common element.” The difference between fixed and changing common elements is whether the element changes from frame to frame. One example of a fixed common element is the backdrop of a news studio. One example of a changing common element is a sign on the news anchor's desk that flashes applause every five seconds. Further examples are provided throughout the text below.

A “dynamic element” is an element that is not the same between multiple copies of the video content. Dynamic elements have two specifically contemplated varieties. The first variety is a “reusable dynamic element. The second variety is a “unique dynamic element”. The reusable dynamic element may also be of the fixed and changing varieties. One example of a fixed reusable dynamic element is an image (e.g., a cherry) on a slot machine reel. One example of a changing dynamic element is the news anchor that may gesticulate with her hands to emphasize a point. A unique dynamic element may be used only once between all the copies of the video content. A special dedication that is inserted into a presentation copy of a DVD might be a unique dynamic element. Examples of all varieties are provided throughout the text below.

A “video clip” is video content that is stored within any storage mechanism for video including an electromagnetic signal or stream of packets that collectively includes the video content. For example, specifically included in the concept of a video clip is a set of data packets from a streaming video source. To make a video clip, a video medium transfer element may be used. Exemplary video medium transfer elements include cd burners, DVD burners, and the mechanism that converts assembled video content into packets and streams them across the network.

Before addressing the particulars of the gaming device embodiment, the present disclosure provides a few alternate embodiments, which help illustrate the strength and flexibility of the present invention. A first alternate embodiment moves away from the gaming environment and focuses on customized video content from amongst a pre-selected palette. For example, this embodiment of the present invention is well suited for video dramatizations of the popular children's CHOOSE YOUR OWN ADVENTURE® books. In such an embodiment, video content is created for each segment or story arc of a book, pre-encoded, and stored. A customer selects the story arcs desired based on their path through the story and provides this information to the vendor. The vendor assembles the appropriate segments of video from the pre-encoded library and burns a DVD for the customer.

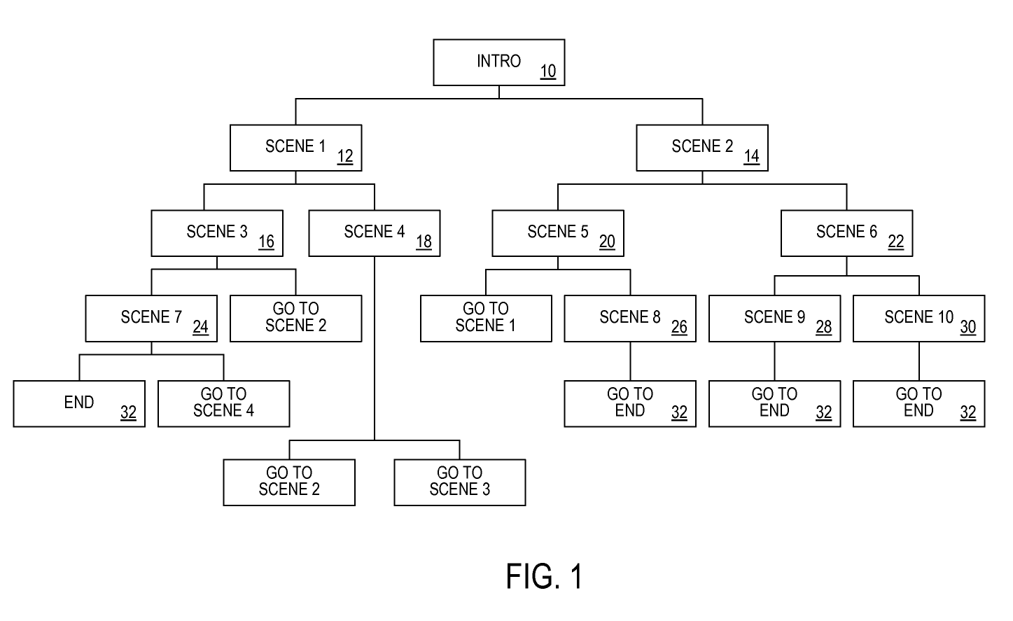

In particular, a rudimentary flow chart of a CHOOSE YOUR OWN ADVENTURE-style book is illustrated in FIG. 1. The story begins at introduction 10 and allows a choice between two paths. The first choice takes the chooser to scene one (box 12). The second choice takes the chooser to scene two (box 14). As illustrated, each scene has a choice of two paths, with scene one (box 12) selecting between scene three (box 16) and scene four (box 18). Likewise, scene two (box 14) selects between scene five (box 20) and scene six (box 22). Scene three selects between scene seven (box 24) and a setback to scene two (box 14). Likewise, scene four has two setback options of scene two (box 14) or scene three (box 16). Scene five (box 20) selects between a setback to scene one (box 12) and scene eight (box 26). Scene six (box 22) selects between scene nine (box 28) and scene 10 (box 30).

Finally, in the next layer of choices, resolution may be achieved. Scene seven selects between an end 32 and a setback to scene four (box 18). Scenes eight, nine, and ten also all refer to end 32. As is readily understood by those familiar with the format, the diagram of FIG. 1 is oversimplified relative to most such stories, but is adequate to illustrate the embodiment.

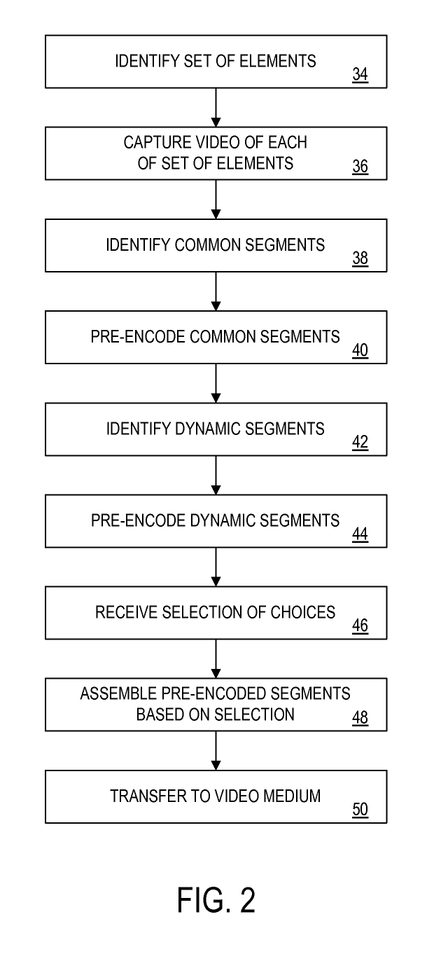

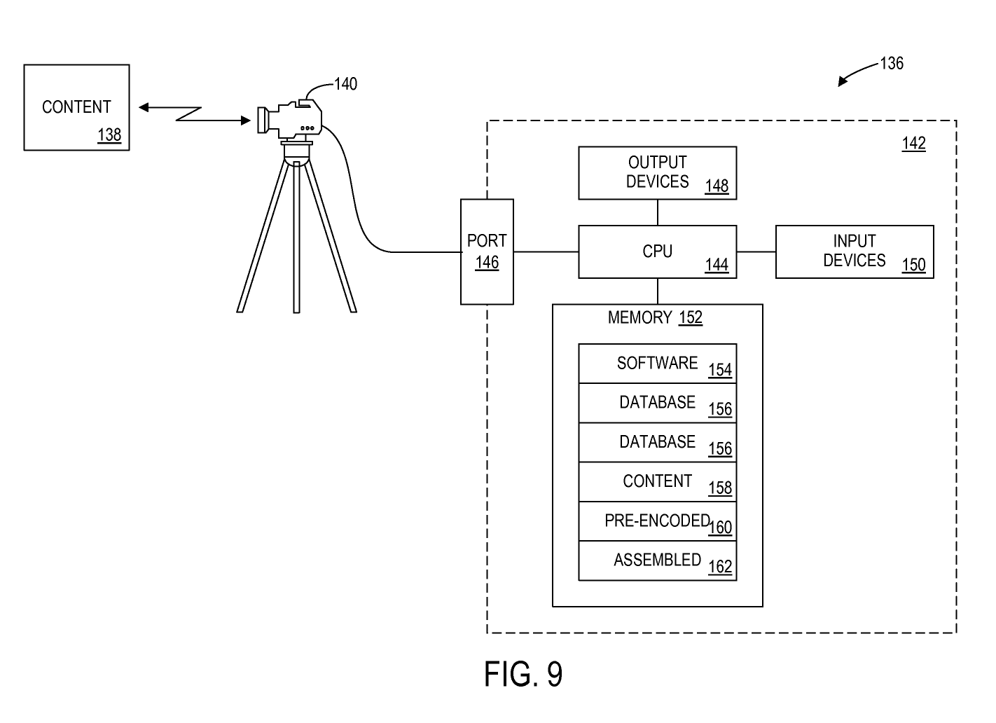

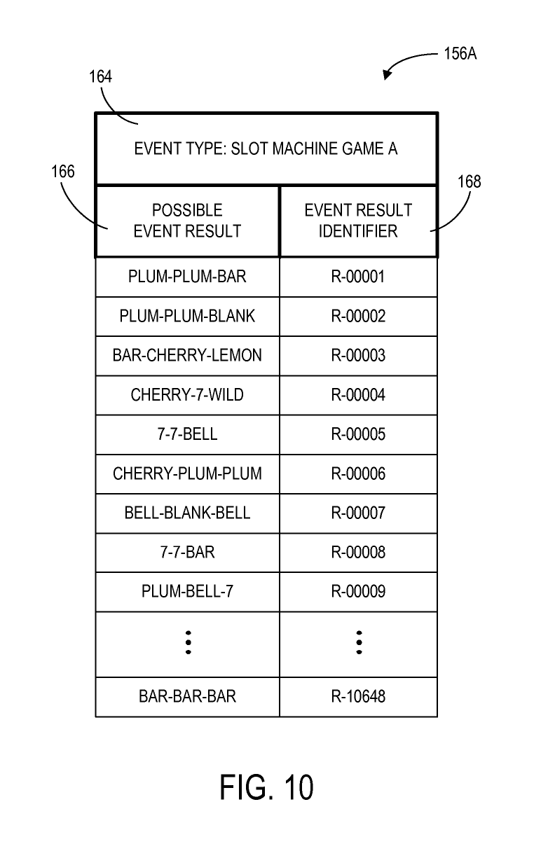

If a movie were to be made of the story represented by FIG. 1, there are numerous permutations that could be implemented in the actual story perceived by the viewer. Rather than film each such permutation separately and encode each such permutation, this embodiment simplifies the process as set forth with reference to FIG. 2. It is presumed that a system such as that discussed with reference to FIG. 9 may implement the methodology set forth in FIG. 2. The system identifies the set of elements within the story (i.e., boxes 10-32) (block 34). Each scene is captured as a video element (block 36), which in this case is actually a video segment, such as by filming with a video camera, animating the scene, or the like.

Within the set of scenes, the common segments are identified (block 38). In the example of FIG. 1, only the introductory scene 10 is common to every copy of the movie made from this story. The introductory scene 10 is probably not a fixed image, and thus is more properly identified as a changing common element. If the introductory scene 10 were preceded by still credits, then the credits might be considered a fixed common element. The common segment(s) are pre-encoded (block 40) according to an encoding algorithm such as by MPEG1, MPEG2, MPEG4, AVC/H.264, RLE, Intel's INDEO™, DivX, H.261, H.263, Windows Media Video, Windows Media Video V9, and the like. This pre-encoded segment is then stored in a memory device such as a computer hard drive.

The dynamic segments are then identified (block 42). In this exemplary embodiment, all the other scenes (boxes 12-32) are dynamic elements and are more properly changing reusable dynamic elements. If the movie had still closing credits that appeared after the end scene 32, then such still closing credits could be considered fixed reusable dynamic elements. The dynamic elements are then pre-encoded and stored in a memory device such as a computer hard drive.

The storyline of the story of FIG. 1 does not include any unique dynamic elements, but one could be included readily, for example, if the introduction 10 (or other scene) was customized for each viewer. Any such unique segments may be pre-encoded and stored in a memory device such as a computer hard drive. Alternatively the encoding of the unique elements may be delayed until assembly of a particular copy of the video content.

After pre-encoding is finished, the system may receive a selection of choices corresponding to the choices in the story (block 46). These choices dictate which scenes should be included in the video and in what order. The system then assembles the pre-encoded segments based on the indicated selection (block 48) (and if a unique element is present and not pre-encoded, it is encoded and added) and transfers the assembled encoded video to a video medium (block 50) to form a video clip. For example, the video may be burned to a DVD, burned to a cd, streamed over the internet, or the like. This process is repeated as needed so that multiple customized video clips may be produced en masse.

As a more detailed example, once all the scenes of the story of FIG. 1 are filmed, pre-encoded, and stored, a first person may indicate to the system that they would like a video based on the story where the protagonist chooses scene two (box 14), scene six (box 22), scene nine (box 28) and ending 32. A second person may indicate to the system that they would like a video based on the story where the protagonist chooses scene one (box 12), scene four (box 18), scene three (box 16), scene two (box 24), scene five (box 20), scene eight (box 26), and ending 32. In each case the pre-encoded segments corresponding to the selected scenes are assembled in the proper order and burned to DVDs that are provided to the requesting parties. The pre-encoding is only done once, and the pre-encoded versions of the segments are used and reused as needed for each copy that is created despite the copies being different from one another.

In the preceding example, the common and dynamic elements conceptually operate at a scene level (e.g., boxes 10-32). Each scene is likely to be a plurality of video frames lasting from approximately ten seconds to five or more minutes. Extending the concept of common and dynamic elements to elements within the scene (e.g., boxes 10-32) or segment provides even greater processing savings in terms of the pre-encoding.

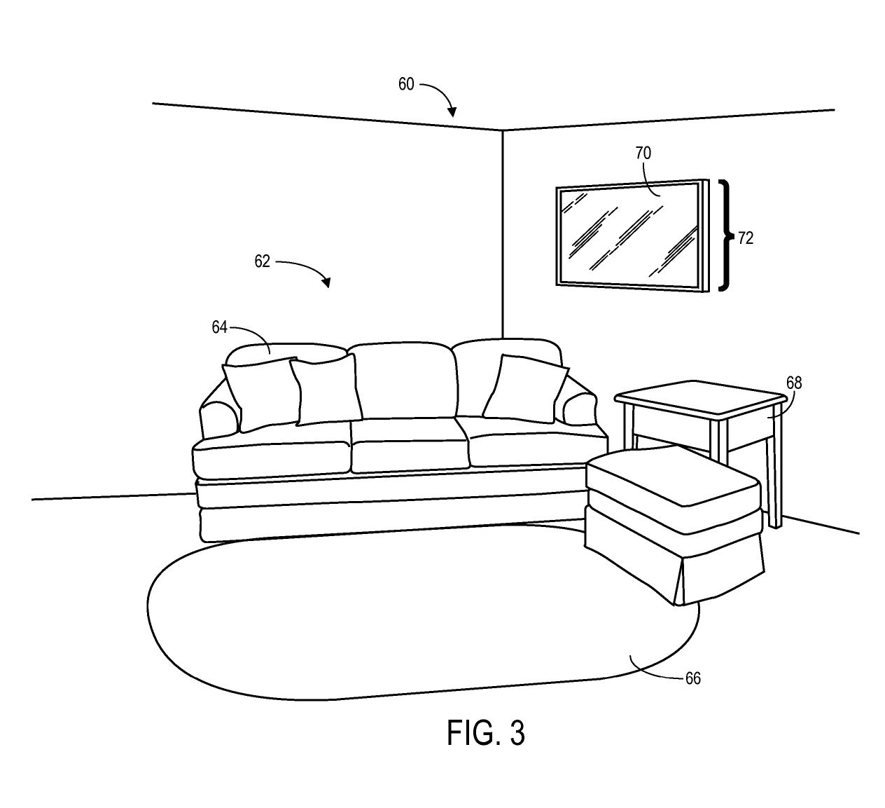

Another illustrative example is provided. In this example, a video corresponds to a television sitcom-style video that has a television continuously playing in the background of each scene. The provider of the video desires to make the content on the television within the video customizable by entities purchasing the video. For example, an exemplary scene 60 is illustrated in FIG. 3. The scene 60 includes a living room 62 with a couch 64, a rug 66, a table 68, and a television 70. The television 70 includes a display 72 on which the customizable content may be presented within the video. If this scene is a set scene that does not change, then elements 62-70 are fixed common elements, the actors moving about the scene (not shown) would be changing common elements. That is, for every copy of the sit corn made, these elements will be common to each copy. The content that appears on the display 72 would be a dynamic element. That is for between different copies of the sitcom, the content on the display 72 may vary, and thus it is dynamic.

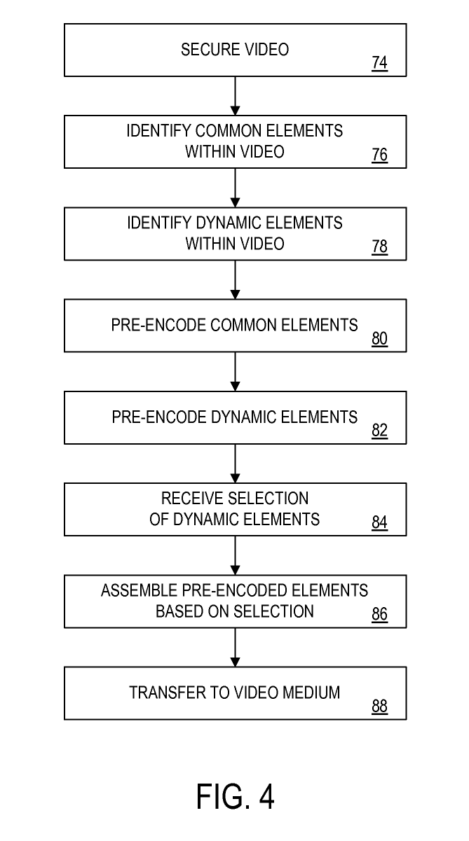

A process illustrating this example is provided with reference to FIG. 4. Specifically, the system secures the video content of the television sitcom-style video (block 74) and identifies the common elements within the video (block 76). As noted above, in this example, the common elements are everything in every frame of the video except the display 72. The system then identifies the dynamic elements within the video (block 78). Conceptually, the set of dynamic elements is the set of all elements minus the set of common elements, and is, in this example, the subject matter presented on the display 72. For the purposes of this example, the provider is trying to promote other television series, and the dynamic elements represent video segments from six other television series, one of which will reappear on every copy made. So, in this example, the subject matter presented on the display 72 is a reusable dynamic element, and most likely a changing reusable dynamic element. The system pre-encodes the common elements (block 80) and the dynamic elements (block 82). Note that the dynamic elements may have to be manipulated to be displayed in the proper perspective depending on the camera angle relative to television 70. However, such perspective reformatting is well understood in the industry.

The system then receives a selection of a dynamic element (block 84) for inclusion on a particular copy of the video of the sitcom-style video. The system assembles the pre-encoded elements based on the selection (block 86) and transfers the assembled pre-encoded data to a video medium (block 88). Thus, for a first copy, the provider selects a first television series (from amongst the six) and assembles its pre-encoded elements with the common elements of the overarching sitcom-style video and burns a DVD. For a second copy, the provider selects a second television series (from amongst the six) and assembles its pre-encoded elements with the common elements of the overarching sitcom-style video and burns a second DVD. If, at a later time, the publisher wishes to add seven more series to the background, then those seven may be pre-encoded as reusable dynamic elements and combined with the already pre-encoded common elements.

Another example of this embodiment would be a television news studio. The studio is a common element, and the on screen personality is a dynamic element that may change from episode to episode. The pre-encoding of the news studio saves processing time and power.

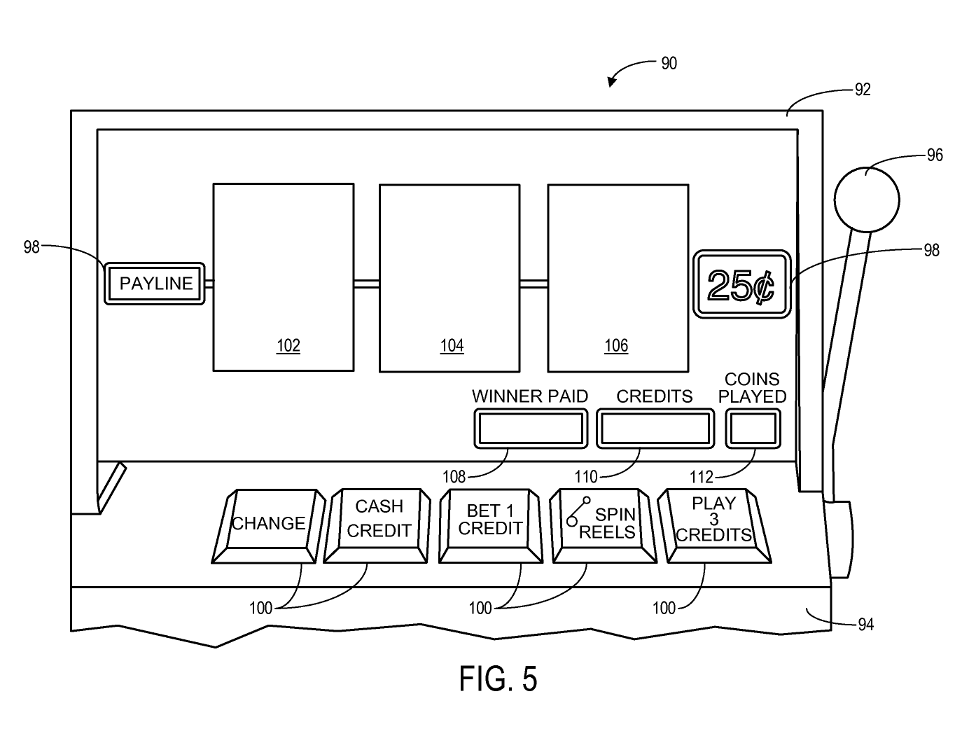

Another example is in the gaming industry where there may be a desire to sell video of a plurality of outcomes of a gaming device. See, for example, commonly owned application Ser. No. 11/333,683, filed Jan. 17, 2006, entitled METHODS AND SYSTEMS FOR DETERMINING AND SELLING WAGERING GAME OUTCOMES TO BE VIEWED REMOTELY, which is hereby incorporated by reference in its entirety. Each copy of the video is unique in that it will have different outcomes thereon, but certain elements, such as the appearance of the gaming device will repeat from copy to copy of the video. Thus, the gaming device will be a common element, but the outcomes will be dynamic between different copies. An example of such an implementation is disclosed in FIG. 5, which illustrates an example frame 90 of a video of a gaming device 92. Such a video may present multiple game plays on the gaming device 92. In this example, the body 94 of the gaming device 92 along with certain indicia and elements of the gaming device 92 remain fixed throughout the entire video. Specifically, the handle 96, the main screen indicia 98, and the buttons 100 are common elements. In contrast, reel windows 102, 104, and 106 are dynamic elements within each frame. Likewise, winner paid field 108, credits field 110, and coins played field 112 may be dynamic elements within each frame.

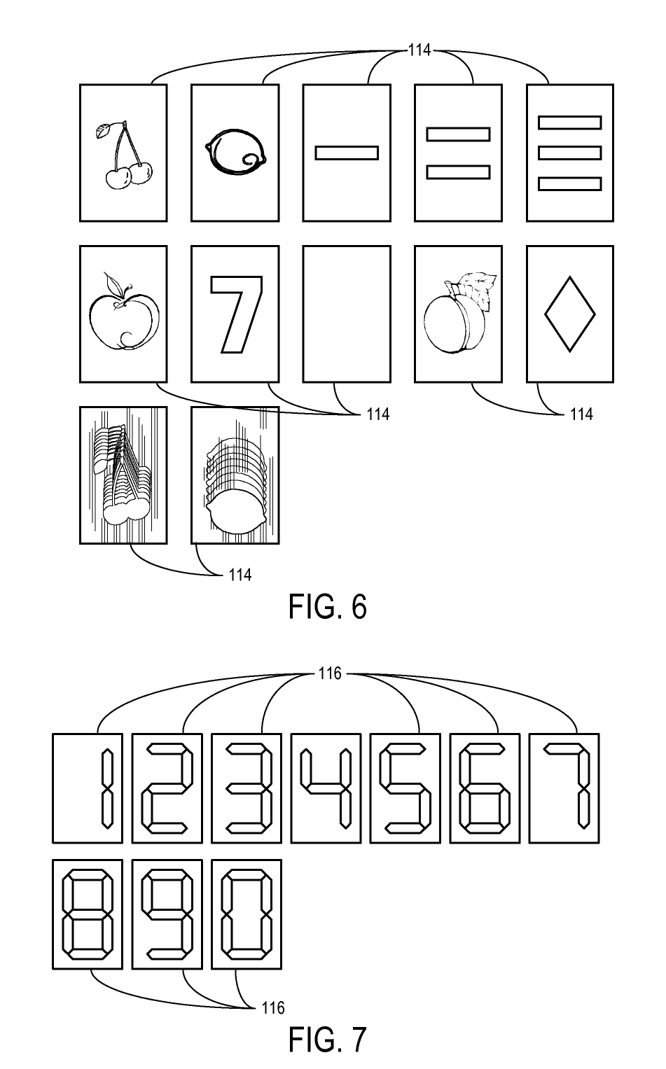

Note that in this embodiment, the dynamic elements may be reusable dynamic elements. For example, exemplary reel images 114 are set forth in FIG. 6 and may appear in any of the reel windows 102, 104, or 106. Likewise, LED style numerals 116 (or other formats of numbers) may be positioned as need in fields 108, 110, or 112.

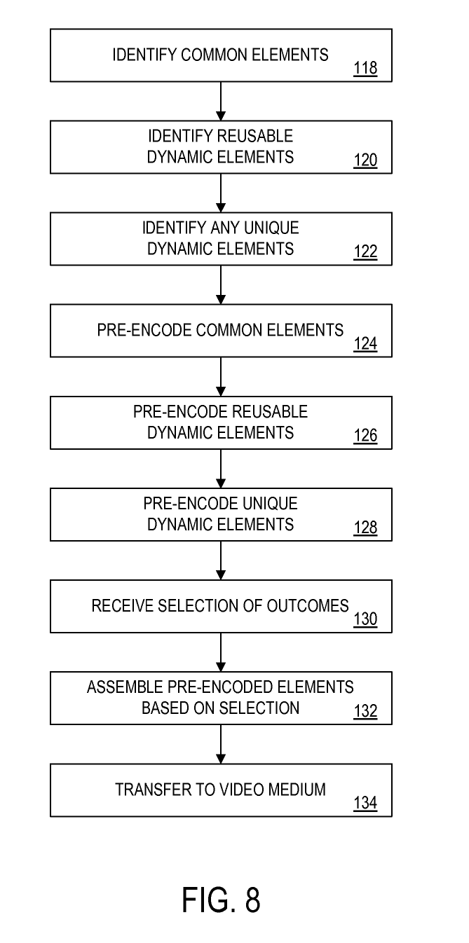

For a typical three-reel slot machine, a large, but finite pool of event results may exist (e.g., if each of the three reels of the slot machine has twenty-two total symbols or “stops” located thereon, there exists 10,648 (22×22×22=10,648) possible reel combinations or outcomes). If an entity desired to sell a video of fifty outcomes of the slot machine, then without the benefit of the present invention, the entity would film the slot machine as it generated fifty outcomes, encode each recording, and transfer the resultant video to a video medium. This process would be repeated each time a new video was desired. This arrangement is highly inefficient. Using the embodiment of FIGS. 1 and 2 is not much more efficient. Each of the 10,648 outcomes would be filmed, pre-encoded, and stored. Then, when a video was needed, the outcomes would be determined (perhaps using the random number generator of a slot machine), and the appropriate pre-encoded outcomes from amongst the library of 10,648 outcomes would be assembled in the manner indicated by the determined outcomes. Instead of performing that many encoding steps, an embodiment of the present invention contemplates the following methodology as illustrated with reference to FIG. 8.

Initially, the system identifies the common elements (block 118). In the example of FIGS. 5-7, the common elements are the body 94, the handle 96, the main screen indicia 98, and the buttons 100. These common elements happen to be fixed common elements. The system also identifies the reusable dynamic elements (block 120) and the unique dynamic elements (block 122). An exemplary unique element might be a special dedication scene or splash shot for the first DVD created in a product line that is used as a presentation copy for a company president or the like. In the example of FIGS. 6 and 7, the reusable dynamic elements are the reel images 114 and the numerals 116. There are no illustrated unique dynamic elements. The system then pre-encodes the common elements (block 124), the reusable dynamic elements (block 126), and the unique (if any) dynamic elements (block 128). Alternatively, unique dynamic elements may be encoded at production time. All of these pre-encoded images are then stored in computer memory or other storage device. Storage of the unique elements is optional. However, given that at some point in the future someone may wish to reuse a unique element, an encoded version of the unique element is likely to be stored, banking against such possible future use.

When the entity desires to make a video with fifty outcomes, the outcomes are determined through any appropriate mechanism, and the system receives a selection of outcomes based thereon (block 130). The system assembles the pre-encoded elements based on the selection (block 132). Thus, for example the common elements are positioned in every frame of the video, and the appropriate reusable dynamic elements are positioned in every frame according to the selection of outcomes received. By pre-encoding the elements before assembly, their reuse is facilitated and processing power is conserved. The assembled video is then transferred to a video medium (block 134).

While the above example explicitly assumes that the image of the gaming device 92 is a fixed common element, the image of the gaming device 92 could be a changing common element. For example, some gaming devices 92 have scrolling lights, flashing lights, or other moving or changing indicia on the body 94. Such a gaming device 92 is still common between different copies, but the common elements are changing common elements. The fact that a common element is a changing common element does not change operation of the present invention.

An exemplary system suitable for implementing embodiments of the present invention is illustrated in FIG. 9. Specifically a system 136 captures content 138 with a camera 140 and provides the content 138 in its original recording form to a computer 142 for processing in accordance with embodiments of the present invention. The computer 142 may comprise a central processing unit (CPU) 144 or other processor that controls a communications port 146, output devices 148, input devices 150, and memory 152.

The camera 140 may communicate with the communications port 146 through any appropriate communications network using an appropriate communications protocol. In an exemplary embodiment the signal between the camera 140 and the communications port 146 is a phase altering line (PAL), a color sequential with memory (SECAM), or national television signal committee (NTSC) signal. Output devices 148 may include speakers, a display, a printer, a DVD burner, a cd burner, a VHS tape recorder, and the like. Input devices 150 may include a mouse, a keyboard, a touch screen, a trackball, a DVD player, a cd player, and the like.

Memory 152 may be a hard drive, random access memory (RAM), read only memory (ROM), a portable USB memory stick, or the like, and may store software 154, databases 156, content database 158, pre-encoded content database 160, and assembled content database 162 therein. The software 154 may include an operating system, video editing software, device drivers, and other software necessary to implement the present invention. A variety of databases 156 may be present as explained in greater detail below. Content database 158 is the original content captured by the camera 140 (or otherwise prepared, such as through animation). The pre-encoded content database 160 stores the common and dynamic content after it has been encoded. The assembled content database 162 stores the finished content prior to being transferred to a video medium.

While it is contemplated that software exists within the memory 152, alternatively, the functionality attributed to the software may be implemented by hard wired circuitry as is well understood. It is also to be understood, that while FIG. 9 illustrates the computer 142 as being a single computer, a distributed computer is also acceptable for the purposes of the present invention.

While the above examples show that embodiments of the present invention may be used in CHOOSE YOUR OWN ADVENTURE-style shows, background material on a television sitcom style show, news show, and gaming device outcome video, the present invention is not so limited and may be used in a trivia game such as the DVD game SCENEIT™ marketed by Screenlife, LLC of Seattle, Wash., coin flips, other casino or lottery game plays such as video poker hands, roulette play, bingo play, keno play, and the like.

In essence, embodiments of the present invention rely on identifying elements that may be reused within multiple portions of a video clip. These elements are pre-encoded once and stored. Optionally, any unique elements, which are not reused, or are selectively reused, are also pre-encoded and stored. Then, the pre-encoded elements are assembled to produce a finished video clip.

A simplified example is provided relative to a three-reel slot machine embodiment, such as that illustrated in FIG. 5 (minus the winner paid field 108, credits field 110, and coins played field 112). After pre-encoding, the common element of the body 94 may be expressed in binary format as a series of ones and zeros. For the sake of example, assume that 1001xxx001010111yyy0101010001zzz0101011 fully describes an encoded frame of video associated with the slot machine of FIG. 5. XXX, YYY, and ZZZ represent the dynamic elements of the reel windows 102, 104, and 106 respectively. Thus, 1001xxx001010111yyy0101010001zzz01010111001xxx001010111yyy0101010001zzz01010111001xxx001010111yyy0101010001zzz0101011 describes three sequential frames of the slot machine. Further, assume that the reel images 114 may be described by a three digit binary code. For example, the cherry symbol is 111, the lemon symbol is 101, a single bar symbol is 001, etc. The common element of the body 94 is pre-encoded and the value is stored (e.g., 1001xxx001010111yyy0101010001zzz0101011). Likewise, each of the reusable dynamic elements of the reel images 114 are pre-encoded (e.g., 001, 111, 101, etc.) and stored. In an exemplary embodiment, this information is stored in pre-encoded content database 160. Then, if the video clip needs to show three frames of an outcome of the slot machine where the outcome is cherry-cherry-bar, then the assembled, the respective pre-encoded elements are assembled: 100111100101011111101010100010010101011100111100101011111101010100010010101011100111100101011111101010100010010101011 such that the pre-encoded dynamic elements are meshed with the pre-encoded common elements. The assembled encoded data represents a video stream that may then be transferred to a video medium such as a DVD, cd, streaming over the internet, or the like.

The previous description is obviously grossly simplified and the details will vary dependent on the encoding scheme used, where in the frame the dynamic element is positioned, the content of the dynamic element, and the like. However, the identification of the common elements and the reusable dynamic elements allows the encoding to be done just once, then the bulk of the processing is in the assembly of the video clip. In an exemplary embodiment, the assembly of the video clip may be done on a frame-by-frame sequential basis. However, since at least MPEG contemplates bi-directional and predictive frames that rely on the information of the preceding and subsequent frames, it is possible that the assembly may be on a frame-by-frame basis in a non-sequential fashion or other fashion so as to accommodate the actual encoding scheme.

As a variation on the present invention, a slightly different approach may still result in processing savings. In this embodiment, content with particular events is identified. Further a set of all possible event results associated with the content is determined.

For example, in some embodiments, a medium (e.g., a DVD) may be produced, the medium comprising one or more media segments indicating the events and/or event results. Returning to the slot machine example, the event type is the slot machine spin, and the event result is the game result, such as an outcome “bar-cherry-bar”. Thus, associated with each event type is a set of all possible event results. Thus, if 10,648 different combinations of reel symbols are possible in association with a particular slot machine game type, the set of all possible event results is the 10,648 unique event results.

Various methods are contemplated for determining a set of all possible event results associated with a particular type of event.

In a first embodiment, a computer device and/or server of the present invention may store, access, or otherwise receive data correlating a set of possible event results to a type of event. Such data may be structured in various manners, and may be stored in one or more databases, such as databases 156. For example, the database 156A of FIG. 10 represents a set of possible results for an event type 164 of “slot machine game A”. As illustrated, the database 156A has two fields. The first field, possible event result field 166, lists each of the 10,648 possible outcomes of a handle spin (only a few illustrated). The second field, the event result identifier field 168, lists a unique identifier for each of the possible event results (e.g., “plum-plum-bar” is uniquely identified as event result “R-00001”).

While not illustrated, the database 156A could be expanded to include different event types and list all possible event results and event result identifiers for all the event types. For example, the event type could be slot machine A, slot machines B, trivia question A, trivia question B, and the like. In this manner media may be created en masse for multiple video content using a single database.

In an exemplary embodiment, some or all of such data for database 156 is received by a computer, such as computer 142 in a variety of manners, such as by (i) receiving an electronic transmission of such data from an external source (e.g., transmitted from a separate computer device via a network), (ii) accessing data stored on volatile or non-volatile media (e.g., accessing data stored in one or more databases maintained by a computer device and/or server, accessing data stored on portable media such as a CD-ROM inserted into a computer device and/or server), (iii) manually receiving such data as it is keyed-in or otherwise entered by an agent or human operator of such a device (e.g., an agent inputs possible event results using various input devices of such computer devices, such as a keyboard, mouse or infrared scanner).

As described, it should also be noted that such data may be received, stored, accessed or determined from a variety of sources, devices or entities. For example, a first source may provide such event result set data, and a computer device of the present invention may then generate one or more unique event result identifiers to be associated with such event results (e.g., using an algorithm for generating such identifiers). In another example, such identifiers may have already been determined and/or associated with various event results at the time a computer device of the present invention accesses such data.

After identification of the set of possible event results, a plurality of video segments may be determined in association with the set of possible event results. In some embodiments, a video segment may span a period of time and thus be a “time segment” that includes a duration of audio and/or video (e.g., a series of analog or digital data that represents ten seconds of video).

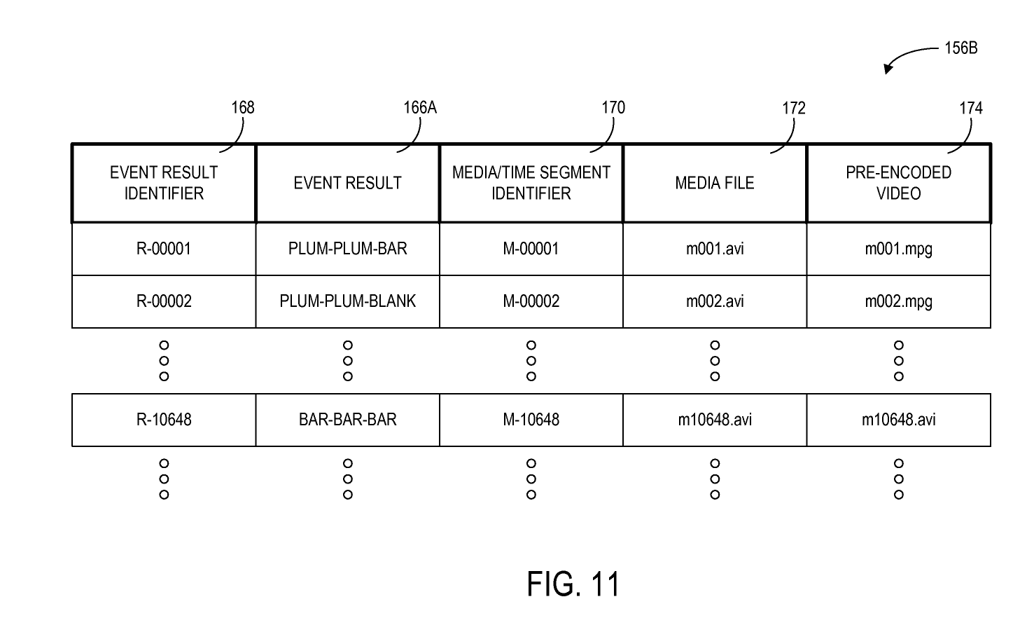

In some embodiments, such time segments may be accessed from a database 156B (illustrated in FIG. 11) correlating one or more of an event result (as identified by event result field 166A) or event result identifier (field 168) with a video/time segment identifier (field 170) and/or media file (field 172). For example, event result identifier R-00002 corresponds to event result plum-plum-blank, video/time segment identifier m-00002 and video file m002.avi (though other formats are contemplated).

These video segments may be pre-encoded according to an encoding algorithm after identification and stored in an appropriate pre-encoded video field 174. While illustrated as being part of the same database 156B, this information and files may be stored in a separate database (not illustrated) or a file system if needed or desired. Further, as described, such one or more databases may comprise alternate or additional fields (e.g., a field indicating whether time segments are designated as common segments or dynamic segments, a field indicating an event type such as “video poker game” or “trivia question,” and so on).

Alternately or additionally, a computer device and/or server of the present invention may be configured to generate or produce such time segments, in effect animating the video segments through computer-generated imagery. A variety of such embodiments are contemplated.

In one example, the computer 142 of the present invention may store software 154 for rendering video representing results of a game such as a gambling game, based on one or more event results. For example, if a determined event result is “bar-cherry-lemon,” the computer 142 of the present invention may utilize software 154 such that video may be created indicating a result of “bar-cherry-lemon.”

In some embodiments, such a software program may render video by animating images, such as by producing a plurality of frames of video wherein images and/or the locations thereof change from one frame of video to the next. For example, a time segment may be produced, and the time segment may be formed from various sectional elements (e.g., various images representing portions of a particular frame are changed and/or moved from frame to frame). For example, to animate a game play of a video poker game, a series of frames of video may be produced whereby the frames display five cards initially being dealt, various cards being held/discarded, and new cards replacing the discarded cards, and so on. In this manner, such a series of video frames (i.e., time segment) may comprise various sectional elements, the sectional elements comprising images that may change from one frame to the next. For example, from a first frame to a second frame, an “Ace of Hearts” card (first sectional element) may replace an image of a blank space (second sectional element) or an image of a different card (third sectional element), and so on. In another example, a first frame of video may comprise an image of a blurred slot machine symbol in a first position, whereas a second frame of video may comprise an image of a blurred slot machine symbol in a second position (e.g., so as to produce the effect that the symbol is moving from frame to frame). Sectional elements are conceptually reusable dynamic elements.

In this manner, one or more component graphics corresponding to reusable dynamic elements for use in such time segments as reel symbols, card faces, buttons, text, numbers (e.g., used in a credit balance), and so on, may be stored as separate graphical files available to such a computer device comprising software for producing video.

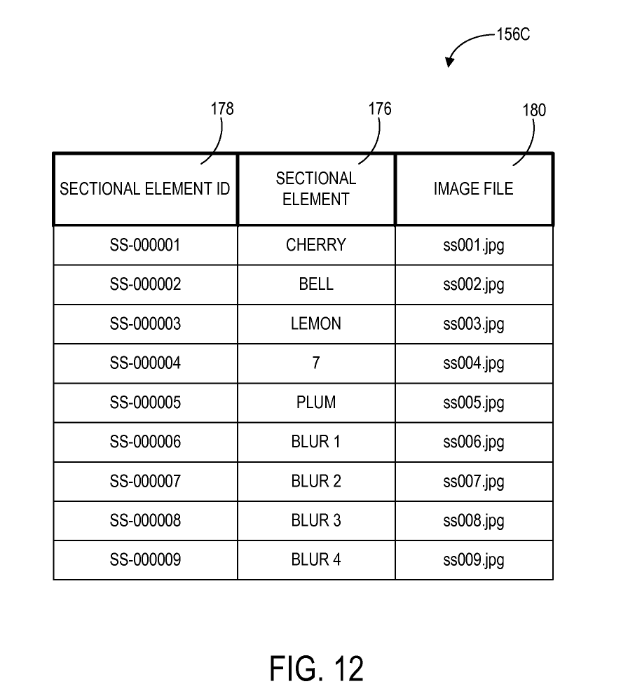

An exemplary sectional element database 156C is illustrated in FIG. 12. For example, if a determined event result is “cherry-bell-lemon”, the database 156C may be accessed, and an appropriate sectional segment (field 176), sectional segment identifier (field 178), and/or image file (field 180) may then be determined (e.g., a .jpg file associated with a “cherry” symbol). In this embodiment, the database 156C is designated for one event type, such as events for slot machine A.

In another example, such a database may include image files and corresponding information for a plurality of event types, such as slot machine A, slot machine B, trivia game, poker game, and the like.

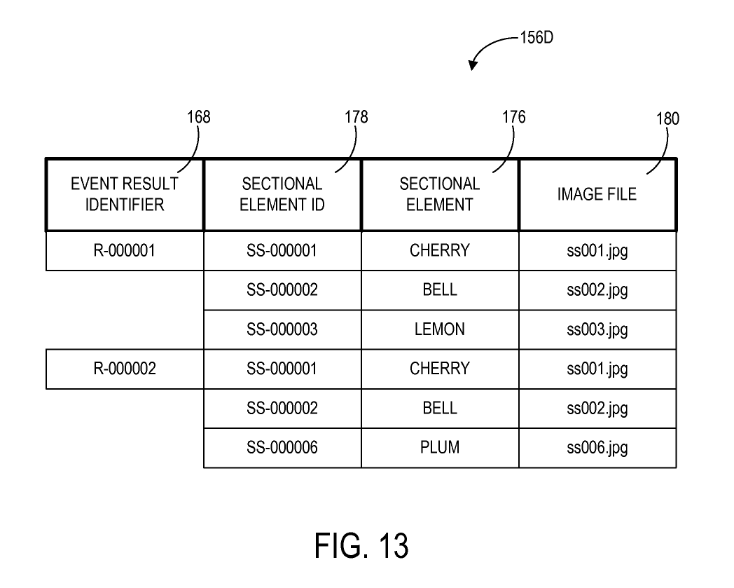

In another example, as illustrated in FIG. 13, the database 156D includes event result identifiers in an appropriate field (field 168). For each event result identifier, the corresponding sectional element identifiers, sectional elements, and image files are provided in appropriate fields (176, 178, and 180), such that based on a determined event result identifier, necessary sectional segments may be determined and retrieved from the database 156D.

Accordingly, in some embodiments, a software program of a computer device of the present invention may be configured to render video that may utilize such stored images (i.e., sectional elements). For example, such a software program may (i) receive or otherwise access data indicating a set of event results which must be rendered, or (ii) receive an instruction (e.g., an input from a user of a computer device, a signal from a separate device) indicating to render one or more particular event results, and so on. In this manner, based on a received event result (e.g., event result identifier), such a software program may determine appropriate sectional elements for use in rendering an appropriate video (e.g., creating a time segment to be used in association with the event result). For example, such software may (i) receive an event result identifier for a particular slot machine game result (e.g., “bar-cherry-lemon”), (ii) access appropriate sectional elements, and (iii) create a series of frames of video incorporating the sectional elements, so as to produce a time segment indicating the received event result identifier.

Various programs are available for rendering video based on received instructions and stored image files. Generally, it is contemplated that such a program may animate such sectional elements by changing such elements or the locations thereof (e.g., a symbol appears to move from one area of the screen to the next as a series of frames are presented). However, it is also contemplated that such a program may incorporate one or more consistent images (e.g., a “background” or “foreground” image, such as a series of buttons of a slot machine that remain constant from the beginning of a spin to the end of a spin, or from spin to spin) that are common to each of the video clips to be created. As described, in some embodiments, such consistent images may be thought of as common sectional elements (e.g., a portion of a frame of video that is consistent between two or more frames). Such common sectional elements may be stored with or separate from the dynamic elements. As noted elsewhere, common sectional elements such as the background of the gaming device are not necessarily consistent frame to frame and may include scrolling indicia, flashing lights or the like so that the common sectional elements are changing common sectional elements.

Thus, in some embodiments, when generating or rendering a time segment in association with a particular event result, various portions or areas of the video may appear to remain the same from frame to frame (a common element), while other portions or areas may change (a dynamic element). Again as noted above, the common elements may be common amongst the video clips, but vary from frame to frame. However, for the sake of the following example, it is assumed that the common element is, in fact, the same from frame to frame.

In some embodiments, a software program of a computer device pre-encoding such a time segment may first determine an appropriate length of such a time segment (although such is not strictly required). For example, a length of such a time segment may be determined based on any or all of: (i) an instruction received (e.g., a signal transmitted from a separate device, an input from a user), (ii) stored data (e.g., a database (not shown) indicates an appropriate length of time in association with a particular time segment to be generated), (iii) an event result associated with the time segment (e.g., as indicated by a database (not shown), a time segment indicating a result of “cherry-bar-bar” of a slot game must be of a first length, whereas a time segment indicating a trivia answer of a trivia game must be of a second length), (iv) an event type associated with the time segment (e.g., slot machine time segments last four seconds, whereas trivia questions last ten seconds), (v) an end of file flag, and so on. Such lengths associated with time segments may be denoted in a variety of manners. For example, such lengths may be denoted in time (e.g., a number of seconds or minutes), frames, and so on.

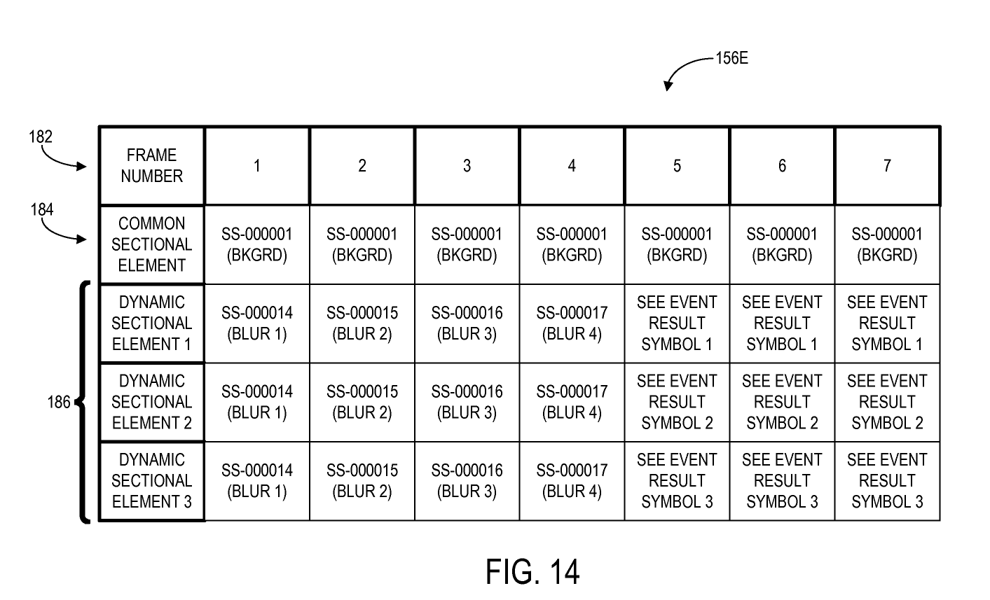

For example, an exemplary data structure of a seven frame time segment arrangement database 156E (depicted by FIG. 14) for a slot machine event may indicate for each frame (field 182) which sectional elements that may be utilized. As illustrated, for each frame, a common sectional element field 184 and a plurality of dynamic element fields 186 are provided. As is readily apparent, the information in the common element field 184 is the same for each frame, but the information for each of the dynamic element fields changes from frame to frame. Thus, the common element may be an element such as a background image that depicts the slot machine. The dynamic elements may indicate that, for a first sectional element (e.g., the reel window 102), a first blur image may be used for a first frame, a second blur image may be used for a second frame, and so on. Further, a determination of which image to use for a particular frame in association with a particular sectional element may be based on an event result for which a time segment is being created. For example, if an event result is “bar-cherry-bar,” the illustrated database 156E indicates that for a fifth frame of dynamic sectional element 1, “SYMBOL 1” (i.e., the “Bar” symbol) is to be used. Of course, it should be appreciated that other dynamic sectional elements may be used in such an embodiment to reflect various game-related activity (e.g., a credit meter updates, a spin button graphic appears to be depressed, and so on). Accordingly, in some embodiments, such a program may then access a sectional element database 156C, such that the appropriate image may be accessed and utilized for the frame. In this manner, frames of video (i.e., a time segment) may be assembled comprising both common and dynamic content, so as to illustrate a particular event result.

As noted above, the assembled video segment may be generated based on the stream of data such as a binary sequence of ones and zeros. Accordingly, series of bits representing the common and dynamic sectional elements may be stored in a database (not shown), such that an initial stream of data representing one or more common sectional elements in association with a plurality of frames of video may be altered based on a given event result, according to certain rules.

Thus, this embodiment may generate a common element, pre-encode the common element and assemble the pre-encoded common element with appropriate pre-encoded dynamic elements based on the event results. This assembly is repeated on a frame-by-frame basis until the time segment is complete. The time segment may then be stored.

It should be noted that a particular event result of a game (e.g., such as “bar-cherry-lemon” of a slot game) may be animated in a plurality of manners, using different graphics, themes, accompanying text, and so on. Thus, it is conceivable that, a plurality of unique DVDs may be produced, each indicating identical game results, but for different slot machines. Alternatively, different results for different gaming devices may be generated as needed or desired.

Embodiments of the present invention comprises methods for (i) determining time segments based on event results by accessing one or more appropriate databases, and/or (ii) generating (e.g., rendering video using a software program) time segments based on event results. Further, as described, other types of media other than video may similarly be determined and/or generated. Embodiments of the present invention may determine and/or generate audio media files. For example, unprepared media files comprising audio or audio/video may be accessed in association with a determined event result from a database storing audio and/or audio/video files.

In some embodiments, the media segment (video, audio or other) for each event result may be generated by a computer device and/or server of the present invention. These media segments may be generated as time segments or as sectional elements depending upon the nature of the event and the combinations of media that can best represent all potential outcomes. These media segments may be generated as animations or otherwise generated automatically by a computer program.

In other embodiments, the media segments may be supplied on a storage media such as DVD, CD-ROM, or on a network. These media segments may be generated as time segments or as sectional elements depending upon the nature of the event and the combinations of media that can best represent all potential outcomes. These media segments are then analyzed and matched to each of the event results in the set of potential event results. In yet another embodiment, the media segments may be filmed or captured with live actors. In yet another embodiment, one portion of a sectional segment may be animated by a computer program, and a second sectional segment may be created by a separate and distinct computer program. For example, the background of a video poker machine may be created by a video software package, while the individual card faces are created with a separate graphic software package. The aforementioned media segments may be stored to a database and associated with each outcome.

It should be noted that, in some embodiments, a single audio file may be associated with a plurality of video files, and vice versa. For example, a single “soundtrack” file may be used in association with a plurality of video files.

As noted elsewhere, the elements are pre-encoded. Other steps may be involved in the pre-encoding process. Various methods for encoding or otherwise preparing such media segments are contemplated. For example, in some embodiments, pre-encoding may comprise accessing a time segment comprising a video file of a first form or format, and pre-encoding the video file such that it may then be stored in a second form or format. For example, in some embodiments, a software program of a computer device of the present invention may access (e.g., based on an input from a user, or based on stored instructions) a video file of a first format (e.g., an avi file) and convert it into a second format (e.g., apply an encoding algorithm such that the file may then be stored as an MPEG-2 format).

Thus, in some embodiments, preparing such media content may comprise (i) pre-encoding the content (including any compression associated with the encoding algorithm or any auxiliary compression such as audio compression based on a Dolby Digital codec or the like), (ii) altering the length of such content (e.g., a “prepared” time segment is formatted to a certain length), (iii) storing additional data associated with such content (e.g., “tags” are associated with certain features or occurrences of the content), (iv) altering or filtering audiovisual properties of such content (e.g., adjusting volume levels; adjusting brightness, contrast or hue; applying noise-gating or other types of filtering; etc.), and/or (v) applying one or more algorithms to such content, and so on. Accordingly, in some embodiments, some embodiment may comprise preparing one or more time segments (e.g., time segments for a set of all possible event results of a particular event type are prepared).

In some embodiments, such prepared time segments may then be stored (e.g., in non-volatile memory) such that they may later be accessed or utilized during a production process (e.g., a process for producing unique media such as unique game-themed DVDs).

Once all the information is processed and pre-encoded, production may begin. In some embodiments, the production process may begin by receiving, accessing, receiving or otherwise determining a description of media to be produced (e.g., if a plurality of DVDs each comprise unique content, such a description may indicate content associated with each DVD). Such a description may be received in a variety of manners and formats. In one embodiment, such a description may comprise a file stored in non-volatile or volatile memory accessible by a computer device and/or server of the present invention. Alternately or additionally, such a file may be received via electronic transmission (e.g., a separate device transmits such a description of unique media to be produced). Further, such a description may be received as a user input (e.g., a user actuates one or more input devices of a computer device so as to provide a description of media to be produced or related data).

In some embodiments, a media description file may indicate a media stream comprising various media segments (e.g., common time segments and dynamic time segments), the media stream associated with a particular unit of media to be produced (e.g., a particular game-themed DVD).

The contents of a plurality of individual units of unique media may have been previously determined (e.g., by an exogenous source). A computer device may be configured to determine contents in association with one or more particular units of media of a batch of such media to be produced (e.g., content is determined for a plurality of unique DVDs). In some embodiments, such content may be determined in a random or semi-random manner. In some alternate embodiments, a random number generator may be used to determine event results to be incorporated with respect to a particular unit of media. Based on a random determination, a game result of a gambling-oriented game may be determined. In another example, based on a random determination, a particular trivia question may be determined. In yet another example, based on a random determination, a particular scene of a movie or clip of an audio program may be determined. In yet another example, event results could be determined directly by a user's play at a real slot machine. For embodiments wherein such contents comprise animated indications or representations of gambling-themed game results, such methods are described in detail in applicant's commonly-owned, co-pending U.S. Provisional Patent Application No. 60/685,604, filed May 27, 2005, entitled “METHODS, SYSTEMS AND APPARATUS FOR PROVIDING GAMBLING RESULTS THAT MAY BE VIEWED REMOTELY,” the entirety of which is incorporated herein by reference for all purposes.

f course, as described, in some embodiments of the present invention, a first and second media stream (e.g., each associated with a particular unit of media), may comprise common time segments (e.g., identical portions of video). For example, each unit of media produced in association with a particular event type (e.g., each DVD of a particular type of trivia game) may comprise the same “intro” and “outro” audio/video segments, segments between questions, and so on. Therefore, in some embodiments, random determinations may determine only a portion of content associated with one or more particular units of media, whereas other portions of content may be predetermined and/or otherwise consistent from unit to unit.

Thus, in some embodiments of the present invention, a media description file may indicate time segments (e.g., both common time segments and dynamic time segments) in association with one or more particular units to be produced. Further, in some embodiments, such a media description file may indicate a sequential order in which such time segments may appear on a given unit of media. In some embodiments, such a media description file may be stored in a media description database (not illustrated).

Such a media description file may indicate time segments (e.g., both common time segments and dynamic time segments) in association with a particular unit of media (e.g., indicated by a unique media unit identifier). Further, such a media description file may indicate a sequence in which such time segments may be incorporated into a media stream associated with such a particular unit of media (e.g., segment #1, segment #2, and so on). Further, in some embodiments, such a database may indicate an event result associated with such segments. Still further, in some embodiments, such a media description file may indicate a group to which the particular unit of media belongs, and/or an event type with which the unit of media may be associated. Thus, in some embodiments, such a media description file may indicate media files (e.g., time segments), which may be utilized when producing a particular unit of media.

In some embodiments, such a description of media to be produced may define various characteristics associated with a particular media stream other than time segments, time segment identifiers, and so on. For example, in some embodiments, such a description of media to be produced may simply define event results associated with a media stream, such that media segments may then be accessed based on the indicated event results such as by using database 156B. Further, in some embodiments, such a description of media to be produced may define various other characteristics associated with a media stream and/or segments thereof (e.g., lengths or durations associated with such one or more segments, other data such as quantitative values associated with such one or more segments, and so on.).

The media stream may then be created based on the description of media to be produced. In some embodiments, a media stream may be associated with a particular unit of media, such as a particular DVD of a batch or group of game-themed DVDs.

The media description file discussed above may indicate a sequential series of media segments which may together comprise a media stream associated with a particular unit of media. Based on the media description file, these media segments may then be accessed from one or more databases such as database 156A.

In some embodiments, a media stream associated with a particular unit of media to be produced may be assembled before the media stream is turned into a video clip. Thus, a software program of a computer device of the present invention may determine a plurality of media files associated with a unit of media, and assemble the separate segment and element files into one composite file, which may be written as a video clip. In a first embodiment, this writing is to the unit such as a DVD. The computer device of the present invention may (i) access a media description file, (ii) determine a first time segment to be included, (iii) access the first time segment (e.g., by accessing a prepared media file associated with a time segment identifier), and (iv) utilize the first time segment when creating a single file representing a media stream. The computer device may then (i) access the media description file, (ii) determine a second time segment to be included, (iii) access the second time segment, and (iv) utilize the second time segment when creating a single file representing a media stream.

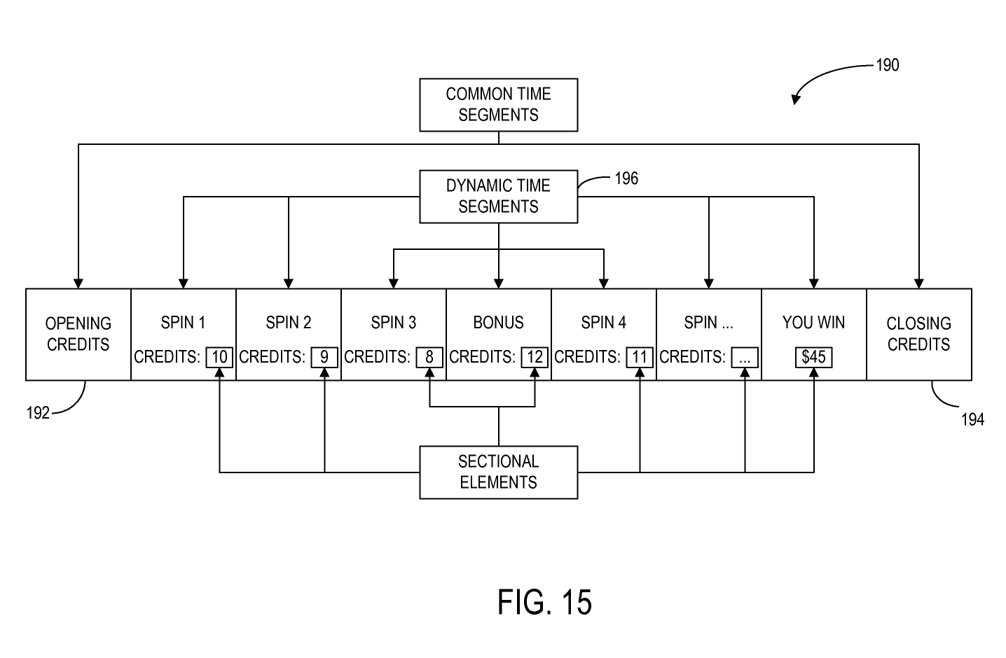

FIG. 15 depicts an exemplary illustration of such a media stream 190. The media stream 190 includes an opening credit segment 192 and a closing credit segment 194, which are common time segments. Furthermore, there are numerous dynamic time segments 196. Each dynamic time segment 196 may include common elements such as the background of the housing 94 of the slot machine and dynamic elements such as the images that are positioned in the reel windows 102, 104, 106. In some embodiments, a database (not shown) may correlate such master media files (e.g., a master MPEG file) to particular units of media, such that a particular master media file may be retrieved when producing a given unit of media.

In another embodiment, each individual prepared media segment may be written separately to a given unit of media (e.g., in succession) For example, a first time segment may be accessed and written to a unit, followed by a second time segment, and so on. Thus, in some embodiments, media segments (e.g., time segments and/or sectional elements) may be written to a unit of media as separate segments, chapters, files, and so on. In yet another embodiment, media segments of various types may be written to one or more units of media in various predetermined orders. For example, in one embodiment, common time segments may be written to a unit of media before or after the dynamic time segments (e.g., standard opening credits are written before individual trivia questions, slot machine spins, scenes of a movie, and so on). In another example, common sectional elements may be written to media before dynamic sectional elements.

In yet another embodiment, a template media stream may be utilized. Such a template media stream may comprise such elements as common time segments and/or common sectional elements. In this manner, dynamic elements such as dynamic time segments and/or dynamic sectional elements may be added to the template based on a media description file, so as to create a final media stream associated with a particular unit of media. In some embodiments, different templates may be associated with different types of events indicated by such media segments associated with various units of media (e.g., a template associated with Slot Machine Game A may be different than a template associated with Trivia Game A). Thus, some embodiments may comprise (i) determining a type of event, (ii) determining a template based on the event (e.g., a database (not shown) correlates event types to templates), and (iii) populating the template with media segments based on a description of media. In this manner, such a populated template may be considered a media stream assembled in conjunction with a particular unit of media to be produced.

As stated, in some embodiments, such media segments may comprise audio/video segments. In other embodiments, audio segments and video segments may be separate, though a unit of media to be produced may require both final audio and video streams. Accordingly, in some embodiments, a plurality of media streams may be assembled in association with a particular unit of media to be produced. For example, in some embodiments, a media description file may indicate a first time segment of a first media type (e.g., a video segment indicating a trivia question) as well as a second time segment of a second media type (e.g., an audio segment featuring accompanying sound effects, such as the sound of a clock ticking). Accordingly, in some embodiments, a plurality of media streams may be assembled, and each of the streams may then be written as a video clip. For example, separate audio and video streams of a DVD may be assembled, such that the streams may then be written to a DVD.

For example, as described, in one embodiment a database (not shown) may correlate particular assembled media streams to particular units of media, such that a particular assembled set of media streams (perhaps already stored as a unified assembled media file) may be retrieved when producing a given unit of media. For example, one or more computer devices of the present invention may be configured to produce a unit of media (e.g., a DVD), and thereby may access such a database, retrieve an associated assembled media file (the DVD version of the assembled media streams), and write the file to the unit of media (the DVD).

Methods of writing such data to such units of media are well known in the art. For example, widely available consumer-grade and producer-grade software and hardware components may be utilized to write such data to media.

For example, in some embodiments, units of media may comprise DVDs. Of course, various types and formats of such DVDs are contemplated. For example, in various embodiments, one or more media files may be written to a DVD in the following formats: DVD-5 (single layer, single side), DVD-9 (dual layer, single side), DVD-10 (single layer, dual side), or DVD-18 (dual layer, dual side). Further, in some embodiments, a DVD may be writable (e.g., a DVD-R), re-writable (e.g., writable and erasable, such as a DVD-RW) and/or may comprise a portion which is writable (e.g., a first portion of a disc in DVD-5 format is pre-recorded and a second portion in DVD-R format is writable). Other formats such as DVD-ROM, DVD-RAM, DVD+R, DVD+RW, and so on, are also contemplated. Further, formats such as BD-ROM, BD-R and/or BD-RE are contemplated (i.e., so-called Blu-ray optical disc formats). Still further such media may be high-definition compatible (e.g., HDTV compatible). Thus, in some embodiments, encoded media files stored on a DVD may be “stamped” using one or more devices designed to replicate a plurality of discs (using a device such as the DVD 8800S injection-molding device offered by Convac Technologies Ltd., one or more polycarbonate layers of such a disc are marked with a spiral series of pits and bumps which may then be decoded by an optical reader device, as is known in the art), or “burned” using an optical device (such as a DVD burner device available in conjunction with most personal computers), such that an optical device may encode a dye layer on such a disc, the dye layer functioning much like the physical pits and bumps produced by a stamping device (e.g., the dye-layer forms non-reflective areas and reflective areas, such that a beam may detect changes in light indicated by the areas, and decode the content accordingly). In other embodiments, such media may comprise a CD or CD-ROM. Additionally, various writable and re-writable formats of such media are contemplated, including CD-R, CD-RW, and so on. Thus, in some embodiments, a computer device of the present invention may comprise a software program as well as a device driver for interfacing with one or more hardware devices (peripheral devices) for writing data to such media.

As stated, in some embodiments, a plurality of media streams may be assembled, and each of the streams may then be written to media (e.g., separate audio and video streams). For example, when authoring a DVD, an MPEG-2 file and compressed audio file may each be written to a Video Object (VOB) file of a DVD disc (a data file used in the DVD format to deliver audio, video and graphics).

In some embodiments, various other formatting may transpire. Various other data that could not be determined prior to the complete assembly of the media segments may be written to media. For example, an index or header file may store such information as total time, total frames, or other data associated with a given unit of media, a media stream, media segments, and so on.

Further, in some embodiments, as described, a plurality of such units of media may be produced. Accordingly, in some embodiments, the present invention may comprise the process of (i) determining a description of a first media unit to be produced, (ii) assembling one or more media streams associated with the first media unit based on the description, (iii) writing the one or more media streams to the first unit, (iv) determining a description of a second media unit to be produced, (v) assembling one or more media streams associated with the second media unit based on the description, (vi) writing the one or more media streams to the first unit and so on.

As described, one or more computer devices, servers and/or other hardware or peripheral devices may be utilized so as to produce such units of media. For example, in some embodiments wherein a media type comprises an optical disc such as a DVD, CD, or CD-ROM, an “assembly line” of computerized and/or mechanized devices may be configured to (i) store appropriate media content on discs, (ii) label such discs, (iii) package such discs (e.g., including adding barcodes, graphics, etc.) and/or (iv) shrink-wrap such packaging. Thus, such a facility may comprise a variety of devices, one or more of which may communicate with one or more databases for determining necessary information for producing such discs. For example, as described, each disc may be unique, and therefore when producing each disc, it may be necessary for various devices to communicate with one or more computer devices, servers and/or databases so as to determine appropriate content for the disc. For example, an assembly unit may comprise a computer system in communication with a mechanized or robotic arm that accesses physical media, such as by lifting a “blank” writable DVD from a spindle of DVDs and placing it into an area in which the disc may subsequently be written to by an optical device. Accordingly, the assembly unit (e.g., the computer system in communication with the mechanized hardware, optical device, etc.) may communicate with a server and/or database that stores one or more descriptions of media to be produced and/or media segments.

In some embodiments, such a facility for producing discs may further be configured to uniquely mark the packaging or labeling of such discs with one or more identifiers or codes. For example, a media unit and/or group identifier may be uniquely marked on the packaging or labeling of a disc, such that the code or identifier may be used to facilitate various steps with respect to the sale and logistics of such discs. Thus, in one example, after a disc has been uniquely encoded with content by a first assembly unit, the disc may then be transferred to one or more second assembly units, which may assist in the labeling and/or packaging of the disc. For example, a second assembly unit may comprise a computer system in communication with various hardware for applying graphics or other labeling to the top side of a disc (e.g., a pressing unit applies permanent color or grayscale images to the top side of the disc). Such a unit may then communicate with one or more databases, such that one or more identifiers associated with the disc may then be determined. In one embodiment, a master computer system may keep track of each disc's position within a series of assembly units, such that when a disc reaches a second assembly unit, the unit may be instructed to label the disc with one or more identifiers. In another example, the unit may determine an identifier by reading the disc (e.g., if the disc was previously encoded with an identifier). In either case, the identifier may then be marked upon the disc. In some embodiments, the identifier may be machine-readable (e.g., a barcode is labeled upon the top of the disc). Alternately or additionally, a human-readable identifier may be labeled upon the disc (e.g., a numeric code is imprinted). In some embodiments, the labeled and encoded disc may then be transported to one or more further assembly units. For example, yet another assembly unit may be responsible for inserting the disc into a jewel case, and/or for shrink-wrapping a jewel case, etc. Other processes such as printing packaging materials (e.g., paper inserts or other paper materials that accompany jewel cases) may or may not take place in such a facility. For example, in one embodiment a separate press may receive instructions for imprinting a paper cover to be inserted into a jewel case with graphics and a unique identifier (e.g., associated with a particular disc). The paper cover may then later be merged and/or otherwise incorporated into such an assembly process (e.g., the cover is matched to a jewel case containing the appropriate disc).

### Alternate Processes

In some embodiments, a computer operator may indicate the areas of the screen which are common with a mouse, delineating the border of the common and the dynamic areas with a line shown on a screen. For example, the areas of the screen and/or the times of the media stream may be indicated in a file which use time and/or location parameters to indicate the delineation of common and dynamic portions of the media stream.

In some embodiments, the common and dynamic portions of the media streams may differ from one set of media streams to the next. For example, the logo may be larger and the reels smaller in a set of media streams produced for one customer relative to a set of media streams produced for a second customer.

In some embodiments, a software program may be configured to analyze a video stream, such that common and/or dynamic portions may be detected.

In some embodiments, the encoded data related to the common portions of the media segment are extracted and stored in a separate data structure with only common portions of the media segment.

In some alternate embodiments, the encoded data is identified and its location stored, but the data remains in the encoded structure along with the data representing the dynamic portions of the exemplary media stream. In these embodiments, the data representing the dynamic portions of the exemplary media stream should not be used in producing a media stream.

In some embodiments where the data representing the common portions of the media are not separate from the dynamic data, the pre-encoded data is stored along with locations of the data representing the common portions. The data and the locations can be stored in any persistent data storage medium or format, such as a file or database.

In some embodiments, the common and the dynamic portions of the media stream are delineated by their position in the frame. This description may be stored as vectors, rectangular areas, etc. For example, the slot reels and credit meters of a video slot reel may be dynamic portions, while the remainder of the frame is a common element.

### Macroblocks

In some embodiments of the present invention, MPEG (e.g., MPEG-2) macroblocks may be utilized. As is known to those of ordinary skill in the art, a macroblock represents a section of a frame of video (commonly a 16 pixel×16 pixel section). Thus, in some embodiments, a sectional element of the present invention may comprise an integer number of MPEG-2 macroblocks.

### Real-Time Streaming

In some embodiments of the current invention, the contents of the media stream may be determined in real time, the media segments assembled, and viewed immediately by the user. In such an embodiment, later media segments of a stream may not yet be assembled or even their event results determined when the first media segments have already been viewed and/or output by the user.

The assembled media stream may be viewed locally on the machine where the assembly occurs, such as on a slot machine. Alternatively, the media stream may be assembled on a central server and then streamed via a network to a remote viewing device where the user views the media stream.

### Alternate Real-Time Streaming

In some embodiments of the current invention, the contents of the media stream may be determined in real time, encoded in real time, and viewed immediately by the user. In such an embodiment, the portion of the media stream that is common is substantially all of the background of the image.

During the production process, the real-time encoding algorithm determines whether a portion of the media stream is common or dynamic, for example by applying motion detection algorithms. If the portion is determined to be part of the background image, the encoded data can be copied from the pre-encoded data generated during the preparation process. If the portion is determined to be part of a dynamic portion, standard real-time encoding algorithms are applied.

### Custom Media

In some embodiments of the present invention, various methods described herein may facilitate the sale of customized media such as customized compact discs or DVDs. For example, in one embodiment, a buyer may indicate the content, which the buyer would like to appear on media such as a DVD, and the DVD may then be produced using some or all of the above-described processes. For example, a buyer may indicate such desired content in a variety of manners, including but not limited to (i) informing a retail agent, (ii) providing a written description of desired content, (iii) using a computer device to transmit an indication of such desired content electronically (e.g., by browsing an Internet site and selecting options for content). For example, a user may visit a Web site and order a customized DVD indicating various content. For example, various different scenes of a movie or other video may be selected, perhaps in a particular order, such that a system of the present invention may produce a unique unit of media using previously prepared audio/video segments, and provide the unit of media to a buyer. Alternatively, a customized birthday script could be made with images from the customer spliced in as dynamic elements against the common element backdrop of the birthday script. Book versions of such birthday scripts are available from RWR Innovations of Papillion Nebr. 68046 and on the web at www.rwrinnovations.com.

### Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Some embodiments can be configured to work in a network environment including a computer that is in communication, via a communications network, with one or more devices. The computer may communicate with the devices directly or indirectly, via a wired or wireless medium such as the Internet, LAN, WAN or Ethernet (or IEEE 802.3), Token Ring, SAP, ATP, Bluetooth, or via any appropriate communications means or combination of communications means. Each of the devices may comprise computers, such as those based on the Intel® Pentium® or Centrino™ T processor, that are adapted to communicate with the computer. Any number and type of machines may be in communication with the computer. Communications over the Internet may be through a website maintained by a computer on a remote server or over an online data network including commercial online service providers, bulletin board systems, and the like. IN yet other embodiments, the devices may communicate with one another and/or a computer over RF, cable TV, satellite links, and the like.

Devices in communication with each other need not be continually transmitting to each other. On the contrary, such computers and devices need only transmit to each other as necessary, and may actually refrain from exchanging data most of the time.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present disclosure.

What is claimed is:

1. A method comprising:
creating a common element that is adapted to be used in a plurality of video clips by identifying where in a frame the common element is to be positioned;
creating a plurality of dynamic elements that may be used in one or more of the plurality of video clips;
pre-encoding the common element as a pre-encoded common element;
pre-encoding each of the plurality of dynamic elements as a plurality of pre-encoded dynamic elements; and
assembling the plurality of video clips using the pre-encoded common element and one or more of the plurality of pre-encoded dynamic elements.

2. The method of claim 1 wherein pre-encoding the common element as a pre-encoded common element includes position information based on where in the frame the common element is to be positioned.

3. The method of claim 1 wherein assembling the plurality of video clips comprises, for a first video clip, using a first one of the plurality of pre-encoded dynamic elements at a first time and a second one of the plurality of pre-encoded dynamic elements at a subsequent time.

4. The method of claim 3 wherein assembling the plurality of video clips comprises, for a second video clip, using the second one of the pre-encoded dynamic elements at a first time and the first one of the plurality of pre-encoded dynamic elements at a subsequent time.

5. The method of claim 1 wherein assembling the plurality of video clips comprises manufacturing a plurality of physical media.

6. The method of claim 1 wherein assembling the plurality of video clips comprises streaming two or more video clips to individuals over the Internet.

7. A method comprising:
identifying a first element of video content as a common element;
identifying a second element of video content as a first reusable dynamic element;
identifying a third element of video content as a second reusable dynamic element;
pre-encoding the first, second, and third elements as a pre-encoded first element, a pre-encoded second element, and a pre-encoded third element;
assembling a first video clip using the pre-encoded first element and the pre-encoded second element; and
assembling a second video clip using the pre-encoded first element and the pre-encoded third element.

8. The method of claim 7 wherein identifying a first element comprises identifying a background element.

9. The method of claim 7 wherein identifying a first element comprises identifying a first element that changes from frame to frame of the video content.

10. The method of claim 7 wherein identifying a first element comprises identifying a gaming device background.

11. The method of claim 7 further comprising identifying a fourth element of video content as a unique dynamic element.

12. The method of claim 7 further comprising identifying a plurality of reusable dynamic elements beyond the first and second reusable dynamic elements.

13. The method of claim 12 further comprising pre-encoding each of the plurality of reusable dynamic elements as a plurality of pre-encoded reusable dynamic elements.

14. The method of claim 13 further comprising assembling a plurality of vide clips, each of the plurality of video clips comprising the pre-encoded first element and one or more of the pre-encoded reusable dynamic elements.

15. The method of claim 7 wherein pre-encoding comprises encoding according to an MPEG algorithm.

16. The method of claim 7 wherein assembling the first video clip comprises assembling on a frame by frame basis.

17. The method of claim 16 wherein assembling on a frame by frame basis comprises assembling frames in a sequential manner.

18. The method of claim 16 wherein assembling on a frame by frame basis comprises assembling frames in a non-sequential manner.

19. A computer readable medium comprising software adapted to:
identify a first element of video content as a common element;
identify a second element of video content as a first reusable dynamic element;
identify a third element of video content as a second reusable dynamic element;
pre-encode the first, second, and third elements as a pre-encoded first element, a pre-encoded second element, and a pre-encoded third element;
assemble a first video clip using the pre-encoded first element and the pre-encoded second element; and
assemble a second video clip using the pre-encoded first element and the pre-encoded third element.

20. A system comprising:
a controller adapted to:
identify a first element of video content as a common element;
identify a second element of video content as a first reusable dynamic element;
identify a third element of video content as a second reusable dynamic element;
pre-encode the first, second, and third elements as a pre-encoded first element, a pre-encoded second element, and a pre-encoded third element;
assemble a first video clip using the pre-encoded first element and the pre-encoded second element; and
assemble a second video clip using the pre-encoded first element and the pre-encoded third element; and
a video medium transfer element adapted to transfer the first video clip to a video medium.

21. A method comprising:
determining a set of all possible event results associated with a gaming device;
identifying a common media segment adapted for re-use with each of the set of all possible events;
identifying reusable dynamic elements within the media segments associated with each of the set of all possible events;
pre-encoding the common media segment as a pre-encoded common media segment;
pre-encoding the reusable dynamic elements as pre-encoded reusable dynamic elements;
storing the pre-encoded common media segment and reusable dynamic elements;
determining a subset of events from the set of all possible events including an order in which the subset of events occurs;
assembling a video clip based on the subset of events using the pre-encoded common element and the pre-encoded reusable dynamic elements associated with the subset; and
preparing a medium on which the video clip is stored.

22. A video clip created by a method comprising:
creating a common element that is adapted to be used in a plurality of video clips;
creating a plurality of dynamic elements that may be used in one or more of the plurality of video clips;
pre-encoding the common element as a pre-encoded common element;
pre-encoding each of the plurality of dynamic elements as a plurality of pre-encoded dynamic elements; and
assembling the video clip using the pre-encoded common element and one or more of the plurality of pre-encoded dynamic elements.

23. A method comprising:
creating a common element that is adapted to be used in a plurality of audio clips;
creating a plurality of dynamic elements that may be used in one or more of the plurality of audio clips;
pre-encoding the common element as a pre-encoded common element;
pre-encoding each of the plurality of dynamic elements as a plurality of pre-encoded dynamic elements; and
assembling the plurality of audio clips using the pre-encoded common element and one or more of the plurality of pre-encoded dynamic elements.
